(19) United States
(12) Patent Application Publication
(10) Pub. No.: US 2024/0302235 A1
(43) Pub. Date: Sep. 12, 2024

(54) APPARATUS AND METHOD FOR PREDICTING ATTENUATION OF PRE-TIGHTENING FORCE OF BOLTS

(71) Applicant: JIANGSU XCMG CONSTRUCTION MACHINERY RESEARCH INSTITUTE LTD., XUZHOU, JIANGSU (CN)

(72) Inventors: Can WANG, XUZHOU, JIANGSU (CN); Peng DING, XUZHOU, JIANGSU (CN); Shuaishuai HAN, XUZHOU, JIANGSU (CN)

(73) Assignee: JIANGSU XCMG CONSTRUCTION MACHINERY RESEARCH INSTITUTE LTD., XUZHOU, JIANGSU (CN)

(21) Appl. No.: 18/272,062

(22) PCT Filed: Nov. 29, 2021
(86) PCT No.: PCT/CN2021/133906

§ 371 Date: Jul. 12, 2023

(30) Foreign Application Priority Data
Nov. 19, 2021 (CN) 202111375331.X

(51) Int. Cl. G01L 5/24; G01L 27/00

(52) U.S. Cl. CPC G01L 5/246; G01L 27/002

(57) ABSTRACT

The present disclosure provides an apparatus and a method for predicting attenuation of a pre-tightening force of a bolt, which relate to the field of prediction on the pre-tightening force of a bolt. The apparatus for predicting attenuation of a pre-tightening force of a bolt includes a pre-tightening force coefficient measuring device, including a clamping assembly, a pre-tightening force detecting assembly, a tightening assembly and a time length measuring assembly. The clamping assembly is configured to fix a bolt to be detected; the pre-tightening force detecting assembly is configured to measure the pre-tightening force to the bolt; the tightening assembly is configured to apply the pre-tightening force to the bolt; the time length measuring assembly is configured to measure a time length of each sampling in the process of tightening the bolt.

### CROSS-REFERENCE TO RELATED APPLICATIONS

This application is based on and claims priority to Chinese Patent Application No. 202111375331.X, filed on Nov. 19, 2021, which is hereby incorporated by reference in its entirety.

### FIELD OF THE INVENTION

The present disclosure relates to the field of prediction on a pre-tightening force of a bolt, in particular to an apparatus and method for predicting attenuation of a pre-tightening force of a bolt.

### DESCRIPTION OF RELATED ART

Bolt connection has the characteristics such as stable connection, good interchangeability and convenience in disassembly, and is thus widely used in construction machinery and equipment. In an actual working process of the construction machinery and equipment, environmental working conditions are harsh, and the impact, load and vibration to be borne are relatively large, which leads to relative rotation between bolts and connected parts, and finally leads to different degrees of attenuation of the pre-tightening force between the bolts and the connected parts, and even looseness of the bolts in severe cases.

The pre-tightening force attenuation process of a bolt connection structure is relatively complex, there are many influence factors, and the loosening degree of bolt connection has a complex nonlinear relationship with many influence factors. In related art, the influence laws of some influence factors are qualitatively summarized through a large number of test data, but since there is no model with a simple form and an accurate prediction accuracy that is used to predict a remaining pre-tightening force of the bolt connection structure under different working conditions and reflect the attenuation degree of the pre-tightening force of the bolt, reliability of the bolt connection structure isn't ensured.

Inventors found that in the prior art, there are at least the following problems: in a bench vibration test process, since it is not easy to detect the pre-tightening force through a pressure sensor in a multi-bolt transverse vibration test, the bench vibration test isn't used to detect the pre-tightening force, leading to few detection means for the pre-tightening force and low detection accuracy. The lack of necessary detecting equipment is also an important factor of inaccurate prediction of the pre-tightening force attenuation process.

### SUMMARY OF THE INVENTION

The present disclosure provides an apparatus and method for predicting attenuation of a pre-tightening force of a bolt, which are used for predicting attenuation characteristics of bolt connection.

Some embodiments of the present disclosure provide an apparatus for predicting attenuation of a pre-tightening force of a bolt, which includes: a pre-tightening force coefficient measuring device, including a clamping assembly, a pre-tightening force detecting assembly, a tightening assembly and a time length measuring assembly; the clamping assembly is configured to fix a bolt to be detected; the tightening assembly is configured to apply a pre-tightening force to the bolt; the time length measuring assembly is configured to measure a time length of each sampling in the process of tightening the bolt by the tightening assembly; and the pre-tightening force detecting assembly is configured to measure the pre-tightening force to the bolt.

In some embodiments, the clamping assembly includes:
a clamp having a first through hole; the first through hole includes a first hole section and a second hole section; an opening size of the first hole section is greater than an opening size of the second hole section; the first hole section is configured to accommodate a head of the bolt, and the second hole section is configured to be penetrated by a rod of the bolt; and
a nut configured to be in threaded connection with part of the rod of the bolt extending out of the second hole section.

In some embodiments, the clamping assembly further includes:
a connector having a second through hole; the connector being disposed between the clamp and the nut.

In some embodiments, the pre-tightening force detecting assembly has a third through hole; and the pre-tightening force detecting assembly is disposed between the connector and the clamp.

In some embodiments, the tightening assembly is connected with the nut to clamp the clamp, the pre-tightening force detecting assembly and the connector which are located between the head of the bolt and the nut by rotating the bolt, so as to apply the pre-tightening force to the bolt.

In some embodiments, the time length measuring assembly includes:
a first piezoelectric ceramic sheet fixedly connected with the head of the bolt;
a first ultrasonic probe disposed corresponding to the first piezoelectric ceramic sheet; and
a driving mechanism in driving connection with the first ultrasonic probe to drive the first ultrasonic probe to move linearly so as to contact and leave the first piezoelectric ceramic sheet.

In some embodiments, the driving mechanism includes:
a driving source including a piston rod; and
an elastic member, one end of which being installed on the piston rod of the driving source, and the other end of which being fixedly connected with the first ultrasonic probe.

In some embodiments, the driving mechanism further includes:
a damping sleeve sleeving the outer part of the first ultrasonic probe and fixedly connected with the piston rod.

In some embodiments, the apparatus for predicting attenuation of a pre-tightening force of a bolt further includes:
a first controller in communication with the first ultrasonic probe to receive ultrasonic signals sent by the first ultrasonic probe.

In some embodiments, the pre-tightening force coefficient measuring device further includes:
a torque sensor connected with the tightening assembly to detect a torque applied by the tightening assembly.

In some embodiments, the apparatus for predicting attenuation of a pre-tightening force of a bolt further includes:
a vibration test device configured to perform a transverse vibration test on the bolt.

In some embodiments, the vibration test device includes:
a vibration table configured to provide vibration;
a support installed on the vibration table;
a first connected part installed on the support;
a second connected part fixedly connected with the first connected part through the bolt;
a second ultrasonic probe configured to detect vibration of the bolt; and
a second piezoelectric ceramic sheet configured to be fixedly connected with the head of the bolt connecting the first connected part and the second connected part;
wherein the direction of vibration motion applied by the vibration table is perpendicular to an axial direction of the bolt in a connected state; in an initial state, the second ultrasonic probe and the second piezoelectric ceramic sheet are kept separated; and in the vibration test, the second ultrasonic probe and the second piezoelectric ceramic sheet are kept in contact.

In some embodiments, the vibration test device further includes:
a bracket installed on the vibration table, and connected with the second connected part to support the second connected part in a vibration direction.

In some embodiments, the vibration test device further includes:
a power component in driving connection with the vibration table to drive the vibration table to vibrate.

In some embodiments, the vibration test device further includes:
a second controller communicatively connected with the second ultrasonic probe to receive ultrasonic signals sent by the second ultrasonic probe.

Some embodiments of the present disclosure further provide a method for predicting attenuation of a pre-tightening force of a bolt, which includes the following steps:
calibrating a pre-tightening force coefficient of a bolt to be detected to obtain a data set of the corresponding relationship between a pre-tightening force and the pre-tightening force coefficient;
performing a transverse vibration test on the bolt to obtain an original data set of the pre-tightening force;
processing the original data set to obtain a target data set; and
establishing, according to the target data set, a pre-tightening force attenuation prediction model.

In some embodiments, the step of processing the original data set to obtain the target data set includes:
performing data recovery on missing data vectors in the original data set by adopting a linear interpolation method, and performing data recovery on abnormal data vectors in the original data set by adopting a mean smoothing method to obtain a processed bolt data set;
enabling the processed bolt data set to form a matrix and performing standardization to obtain a covariance matrix, and sorting eigenvalues of the covariance matrix from large to small to calculate a contribution rate of each influence factor to all influence factors; wherein the influence factor meeting the cumulative contribution rate greater than a set value is a pre-tightening force attenuation key influence factor; and the target data set is a set of the pre-tightening force attenuation key influence factors.

In some embodiments, the set value is 80%-90%.

In some embodiments, the step of establishing the pre-tightening force attenuation prediction model according to the target data set includes:
constructing a support vector regression prediction model, and taking the target data set composed of the pre-tightening force attenuation key factors as input vectors and corresponding pre-tightening forces thereof as outputs; and training the support vector regression prediction model, and giving a confidence interval of the pre-tightening force of the bolt in probability sense to predict attenuation characteristics of a bolt connection structure.

In some embodiments, the step of training the support vector regression prediction model and giving the confidence interval of the pre-tightening force of the bolt in probability sense to predict the attenuation characteristics of the bolt connection structure includes:
preprocessing an experimental data pair model obtained from the vector regression prediction model to construct a training set;
determining, according to the training set, a kernel function;
constructing an optimization function, and solving by taking a sample set composed of tested key influence factors and the corresponding pre-tightening forces as inputs; and
solving an optimal decision function, and predicting the corresponding pre-tightening forces by a sample set composed of untested key influence factors under specified working conditions.

In some embodiments, the function xi of the training set is as follows:

$${x}_{i} = \{ {q}_{i} ( t ) , {q}_{i} ( t - 1 ) , … , {q}_{i} ( t - n ) \}$$

wherein qi(t) is the pre-tightening force corresponding to a current vibration frequency segment, and qi(t−1) is the pre-tightening force corresponding to a previous vibration frequency segment; qi(t−n) is the pre-tightening force corresponding to first n vibration frequency segments.

In some embodiments, the kernel function k(x,xi) is:

$$k ( x , {x}_{i} ) = {k}_{R B F} ( x , {x}_{i} ) + {k}_{LIN} ( x , {x}_{i} )$$

$$Wherein$$

$$\begin{matrix}{k}_{R B F} ( x , {x}_{i} ) = exp ( - γ {‖ x - {x}_{i} ‖}^{2} ) \\ {k}_{LIN} ( x , {x}_{i} ) = {x}^{T} \cdot {x}_{i}\end{matrix}$$

x is the vector composed of input variables corresponding to a predicted value; x^{T} is a transposition matrix of x; xi is the vector composed of input variables corresponding to the sample set; γ is a signal error.

In some embodiments, the optimization function is as follows:

$$\{ \begin{matrix}min \{ \frac{1}{2} {\sum }_{i , j = 1}^{N} ( {a}_{i}^{*} - {a}_{i} ) ( {a}_{j}^{*} - {a}_{j} ) K ( {x}_{i} , {x}_{j} ) - {\sum }_{i = 1}^{N} ( {a}_{i}^{*} - {a}_{i} ) {y}_{i} + {\sum }_{i = 1}^{N} ( {a}_{i} + {a}_{i}^{*} ) ε \} \\ s . t . {\sum }_{i = 1}^{N} ( {a}_{i}^{*} - {a}_{i} ) = 0 , 0 \leq {a}_{i} , {a}_{i}^{*} \leq C , i = 1 , 2 , … , N\end{matrix}$$

wherein xi and xj represent the vectors composed of different input variables; N is the number of samples, and aᵢ, a*ᵢ, aⱼ, a*ⱼ are lagrangian multipliers; C is a penalty factor; and ε is an error value.

In some embodiments, the decision function is as follows:

$$f ( x ) = {\sum }_{i = 1}^{N} ( {a}_{i}^{*} - {a}_{i} ) K ( {x}_{i} , x ) + b$$

wherein x represents the vector composed of input variables corresponding to the predicted value, xi represents the vector composed of input variables corresponding to the sample set, aᵢ, a*ᵢ are lagrangian multipliers, and b is a coefficient of the decision function.

For the apparatus for predicting attenuation of a pre-tightening force of a bolt according to the above technical solution, a bolt pre-tightening force coefficient is measured and calculated at first, so as to realize subsequent construction of a support vector regression model. The support vector regression model solves the nonlinear problem of more influence factors in determination of the attenuation characteristics of the pre-tightening force of the bolt, and the pre-tightening force of the bolt is detected quickly and effectively by using the apparatus for predicting attenuation of a pre-tightening force of a bolt, which provides the corresponding original data set for the bolt pre-tightening force attenuation prediction model. The data model between the attenuation and characteristics of the pre-tightening force of the bolt is established by support vector regression, the variation and probability distribution of the pre-tightening force of the bolt with a vibration period under different working conditions are predicted, and the confidence interval in probability sense is given, thereby reflecting the dispersion of a pre-tightening force attenuation process of the bolt more accurately, and being of great significance to an anti-loosening design and a maintenance cycle of bolt connection.

### BRIEF DESCRIPTION OF THE DRAWINGS

FIG. 1 is a schematic structural sectional view of a pre-tightening force coefficient measuring device of an apparatus for predicting attenuation of a pre-tightening force of a bolt according to some embodiments of the present disclosure.

FIG. 2 is a schematic diagram of a three-dimensional structure of a clamp of a pre-tightening force coefficient measuring device of an apparatus for predicting attenuation of a pre-tightening force of a bolt according to some embodiments of the present disclosure.

FIG. 3 is a schematic diagram of a front view structure of a clamp of a pre-tightening force coefficient measuring device of an apparatus for predicting attenuation of a pre-tightening force of a bolt according to some embodiments of the present disclosure.

FIG. 4 is a schematic structural sectional view of a clamp of a pre-tightening force coefficient measuring device of an apparatus for predicting attenuation of a pre-tightening force of a bolt according to some embodiments of the present disclosure.

FIG. 5 is a schematic diagram of a three-dimensional structure of a connector of a pre-tightening force coefficient measuring device of an apparatus for predicting attenuation of a pre-tightening force of a bolt according to some embodiments of the present disclosure.

FIG. 6 is a schematic diagram of a group of ultrasonic signals obtained by a time length measuring assembly of a pre-tightening force coefficient measuring device of an apparatus for predicting attenuation of a pre-tightening force of a bolt according to some embodiments of the present disclosure.

FIG. 7 is a schematic diagram of a bolt effective clamping length corresponding to an apparatus for predicting attenuation of a pre-tightening force of a bolt according to some embodiments of the present disclosure.

FIG. 8 is a schematic diagram of a three-dimensional structure of a vibration test device of an apparatus for predicting attenuation of a pre-tightening force of a bolt according to some embodiments of the present disclosure.

FIG. 9 is a schematic diagram of a prediction structure obtained by a method for predicting attenuation of a pre-tightening force of a bolt according to some embodiments of the present disclosure.

FIG. 10 is a schematic diagram corresponding to the 95% confidence interval of FIG. 9.

### DESCRIPTION OF THE INVENTION

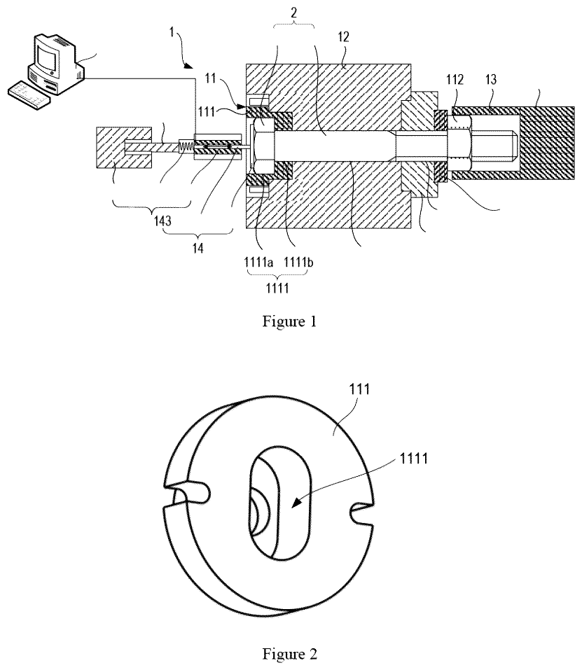

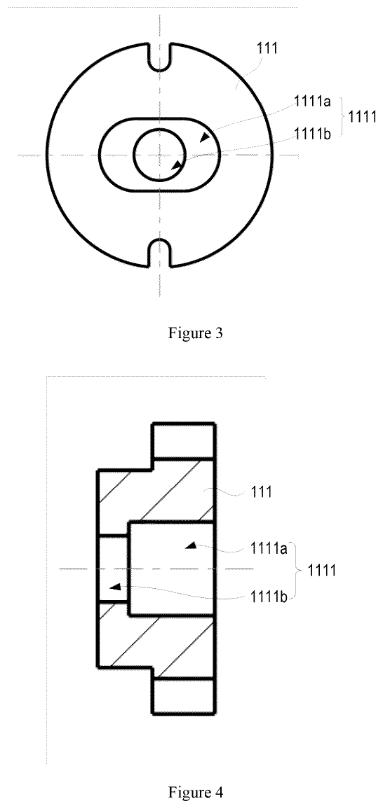

The technical solution according to the present disclosure will be described in more detail in combination with FIGS. 1 to 10.

Some embodiments of the present disclosure provides an apparatus for predicting attenuation of a pre-tightening force of a bolt, which includes a pre-tightening force coefficient measure device 1. The pre-tightening force coefficient measuring device 1 includes a clamping assembly 11, a pre-tightening force detecting assembly 12, a tightening assembly 13 and a time length measuring assembly 14. The clamping assembly 11 is configured to fix a bolt 2 to be detected. The tightening assembly 13 is configured to apply a pre-tightening force to the bolt 2. The time length measuring assembly 14 is configured to measure a time length of each sampling in the process of tightening the bolt 2 by the tightening assembly 13. The pre-tightening force detecting assembly 12 is configured to measure the pre-tightening force to the bolt 2.

Referring to FIGS. 1 to 3, the clamping assembly 11 is used to clamp and fix the bolt 2 to be measured, and prevent the bolt 2 from the situations such as rotating, which will affect the measurement, in the tightening process. In some embodiments, the clamping assembly 11 includes a clamp 111 and a nut 112. The clamp 111 has a first through hole 1111, and the first through hole 1111 is configured to be penetrated by a rod 2b of the bolt 2 and block a head 2a of the bolt 2 from passing through. The head 2a of the bolt 2 is located at one end of the clamp 111 in the axial direction, and the rod 2b of the bolt 2 extends out of the first through hole 1111. The nut 112 is configured to be connected with the rod 2b of the bolt 2.

Referring to FIGS. 1 to 3, the first through hole 1111 includes a first hole section 1111a and a second hole section 1111b. The first through hole 1111 includes the first hole section 1111a and the second hole section 1111b. An opening size of the first hole section 1111a is greater than an opening size of the second hole section 1111b. The first hole section 1111a is configured to accommodate the head 2a of the bolt 2, and the second hole section 1111b is configured to be penetrated by the rod 2b of the bolt 2. The nut 112 is configured to be in threaded connection with part of the rod 2b of the bolt 2 extending out of the second hole section 1111b.

Referring to FIGS. 2 to 4, the first hole section 1111a is configured as a non-circular hole, specifically, as a structural form such as an oblong hole and an elliptical hole. Due to the hole in these shapes, the bolt 2 cannot rotate after being installed in the first hole section 1111a, which plays a role in fixing the bolt 2 in the circumferential direction, so that the nut 112 can be connected with threads of the bolt 2 by screwing the nut 112 later.

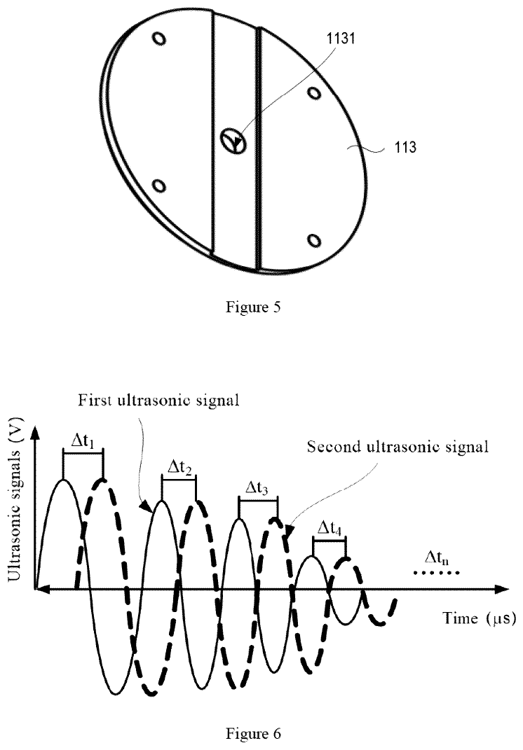

Referring to FIGS. 1 and 5, in order to apply the pre-tightening force to the bolt 2 more effectively, in some embodiments, the clamping assembly 11 further includes a connector 113 having a second through hole 1131; and the connector 113 is disposed between the clamp 111 and the nut 112.

For example, the connector 113 adopts a disk or other plate-like or sheet-like structures. When the connector 113 is added to lock the bolt 2 and the nut 112, the pre-tightening force is applied to the clamp 111 and the connector 113.

With continued reference to FIG. 1, in some embodiments, the pre-tightening force detecting assembly 12 has a third through hole 121; the pre-tightening force detecting assembly 12 is disposed between the connector 113 and the clamp 111. For example, the pre-tightening force detecting assembly 12 adopts a force sensor, and the pre-tightening force between the bolt 2 and the nut 112 is accurately and timely measured by the force sensor. Moreover, the whole pre-tightening force coefficient measuring device 1 adopts a relatively compact structure, and the bolt 2 to be measured connects the clamp 111, the connector 113, the pre-tightening force detecting assembly 12 and the nut 112 into a whole. By directly applying the pre-tightening force to the nut 112, the pre-tightening force can be directly transmitted to the pre-tightening force detecting assembly 12, so that the pre-tightening force does not need to be converted or other transfer parts during measurement, a force transmission path is shorter and the measurement is more efficient and accurate.

In order to facilitate the tightening of the nut 112, in some embodiments, the tightening assembly 13 is connected with the nut 112 to clamp the clamp 111, the pre-tightening force detecting assembly 12 and the connector 113 which are located between the head 2a of the bolt 2 and the nut 112 by rotating the nut 112, thereby applying the pre-tightening force to the bolt 2.

One side of the pre-tightening force detecting assembly 12 is attached to the end surface of the clamp 111 away from the first hole section 1111a, and the other side of the pre-tightening force detecting assembly 12 is attached to the connector 113. The pre-tightening force detecting assembly 12 has a larger contact area with the clamp 111 and the connector 113. For example, the tightening assembly 13 is specifically a tightening machine, a torque wrench, etc. By rotating the tightening assembly 13, the nut 112 is driven to rotate therewith, thereby locking the clamp 111, the pre-tightening force detecting assembly 12 and the connector 113 which are clamped between the nut 112 and the head 2a of the bolt 2.

With continued reference to FIG. 1, in some embodiments, the apparatus for predicting attenuation of a pre-tightening force of a bolt further includes a torque sensor 16, and the torque sensor 16 is connected with the tightening assembly 13 to detect a torque applied by the tightening assembly 13. Specifically, the torque sensor 16 is fixed to the tightening assembly 13, or the torque sensor 16 is integrated with the tightening assembly 13. The tightening assembly 13 is matched with the nut 112 to apply the pre-tightening force to the nut 112. In the process of tightening the nut 112 by the tightening assembly 13, the torque needs to be applied, and the torque sensor 16 is used to measure a value of the applied torque.

With continued reference to FIG. 1, in some embodiments, the pre-tightening force coefficient measuring device 1 further includes a gasket 114, and the gasket 114 is disposed between the nut 112 and the connector 113. A contact area between the gasket 114 and the connector 113 is greater than a contact area between the nut 112 and the connector 113, so that the threaded connection is more reliable.

With continued reference to FIG. 1, in some embodiments, the time length measuring assembly 14 includes a first piezoelectric ceramic sheet 141, a first ultrasonic probe 142, and a driving mechanism 143. The first piezoelectric ceramic sheet 141 is configured to be fixedly connected with the head 2a of the bolt 2, and specifically, is adhered and fixed by using thread glue or the like. The driving mechanism 143 is in driving connection with the first ultrasonic probe 142 to drive the first ultrasonic probe 142 to move linearly so as to contact and leave the first piezoelectric ceramic sheet 141.

The first piezoelectric ceramic sheet 141 is an electronic sounding element, and a piezoelectric ceramic dielectric material is placed between two copper circular electrodes. When an alternating current audio signal is connected to the two electrodes, the first piezoelectric ceramic sheet 141 vibrates according to a magnitude and frequency of the signal to generate a corresponding sound. In some embodiments introduced in the present disclosure, the first piezoelectric ceramic sheet 141 is used to receive and transmit ultrasonic signals. When the nut 112 is not tightened, the first ultrasonic probe 142 does not contact the first piezoelectric ceramic sheet 141. In the process of tightening the nut 112, the first ultrasonic probe 142 is in contact with the first piezoelectric ceramic sheet 141 to receive the ultrasonic signals. When the nut 112 is tightened, the ultrasonic signals are continuously generated from the head 2a of the bolt 2. For any sampling moment in the tightening process, a first ultrasonic signal (also called the first ultrasonic signal) is generated, and the first ultrasonic signal is transmitted to the first ultrasonic probe 142 through the first piezoelectric ceramic sheet 141 and collected. In addition, when transmitted to the tail end of the rod 2b of the bolt 2, the first ultrasonic signal is emitted back, and a second ultrasonic signal (also called the second ultrasonic signal) is generated. The second ultrasonic signal will also be transmitted to the first ultrasonic probe 142 through the first piezoelectric ceramic sheet 141 and collected. The two ultrasonic signals collected at one sampling moment are shown in FIG. 6. According to the first ultrasonic signal and the second ultrasonic signal, the time difference Δt required later is obtained.

The driving mechanism 143 is used to change a position of the first ultrasonic probe 142, so that the first ultrasonic probe 142 is in contact with or leaves the first piezoelectric ceramic sheet 141. When it is necessary to detect the ultrasonic signals of the bolt 2, the first ultrasonic probe 142 is kept in contact with the first piezoelectric ceramic sheet 141. The first ultrasonic probe 142 is kept apart from the first piezoelectric ceramic sheet 141 when it is unnecessary to detect the ultrasonic signals of the bolt 2.

Referring to FIG. 1, in some embodiments, the driving mechanism 143 includes a driving source 1431 and an elastic member 1432. The driving source 1431 includes a piston rod 1431a; one end of the elastic member 1432 is installed at the piston rod 1431a of the driving source 1431, and the other end of the elastic member 1432 is fixedly connected with the first ultrasonic probe 142.

For example, the driving source 1431 is an air cylinder, an oil cylinder, an electric cylinder and other parts. Each of these parts has a telescopic rod, and the first ultrasonic probe 142 is driven to move linearly by linear movement of the telescopic rod. The telescopic rod extends, and the first ultrasonic probe 142 moves towards the first piezoelectric ceramic sheet 141; and the telescopic rod retracts, and the first ultrasonic probe 142 is away from the first piezoelectric ceramic sheet 141. By adopting this form, it is not necessary to change a motion form, which is more conducive to accurate control over a displacement of the first ultrasonic probe 142. Further, the first ultrasonic probe 142 is fixedly connected with the piston rod 1431a through the elastic member 1432. When the first ultrasonic probe 142 is in contact with the first piezoelectric ceramic sheet 141, the elastic member 1432 plays a buffering role, reduces the impact between the first ultrasonic probe 142 and the first piezoelectric ceramic sheet 141, and avoids the excessive impact therebetween, thereby reducing the interference to the first piezoelectric ceramic sheet 141. Moreover, after the first ultrasonic probe 142 is in contact with the first piezoelectric ceramic sheet 141, the elastic member 1432 keeps the first ultrasonic probe 142 in contact with the first piezoelectric ceramic sheet 141 all the time in the tightening process of the bolt 2 and the nut 112 through an elastic force.

With continued reference to FIG. 1, in some embodiments, the driving mechanism 143 further includes a damping sleeve 1433, and the damping sleeve 1433 sleeves the outer part of the first ultrasonic probe 142 and is fixedly connected with the piston rod 1431a.

For example, the damping sleeve 1433 adopts a cotton sleeve, a rubber sleeve, etc. The damping sleeve 1433 and the piston rod 1431a are fixedly connected by means of gluing, riveting, etc. The damping sleeve 1433 sleeves the outer part of the first ultrasonic probe 142, thereby further reducing vibration of the first ultrasonic probe 142 and reducing measurement errors. The damping sleeve 1433 and the elastic member 1432 cooperate with each other to play a role of secondary damping, which further improves the measurement accuracy of the first ultrasonic probe 142.

In some embodiments, the apparatus for predicting attenuation of a pre-tightening force of a bolt further includes a first controller 15, and the first controller 15 is in communication connection with the first ultrasonic probe 142 to receive the ultrasonic signals sent by the first ultrasonic probe 142. For example, the first controller 15 adopts a computer or an industrial controller.

Next, the use process of the pre-tightening force coefficient measuring device 1 is introduced.

For each bolt 2 to be subjected to the prediction on attenuation of the pre-tightening force, the pre-tightening force coefficient is measured by the pre-tightening force coefficient measuring device 1 at first.

Step 1, the bolt 2 to be measured is installed in place, and the threaded connection between the nut 112 and the bolt 2 is enabled to have no pre-tightening force, that is, the nut 112 and the bolt 2 are not tightened.

Step 2, the position of the first ultrasonic probe 142 is adjusted, so that the first ultrasonic probe 142 is in contact with the first piezoelectric ceramic sheet 141. If a sine wave signal is measured by the first ultrasonic probe 142 after the two are in contact, it means that the first piezoelectric ceramic sheet 141 is effective and the subsequent steps can be carried out. If external environment is harsh, for example, there are phenomena such as larger noise and vibration, or the contact between the first ultrasonic probe 142 and the first piezoelectric ceramic sheet 141 is poor, and the first ultrasonic probe 142 does not measure the sine wave signal, it is necessary to eliminate the interference, and then the subsequent measurement operation is performed after the sine wave signal is obtained.

Step 3, a target pre-tightening force is set, and the nut 112 is tightened according to the target pre-tightening force. In the tightening process, the pre-tightening force detecting assembly 12 is used to collect pre-tightening force data, and the time length measuring assembly 14 is used to collect the ultrasonic signals. The target pre-tightening force is set according to working conditions of the bolt 2, and may also be set to 70%-80% of a guaranteed load of the bolt 2. The guaranteed load of the bolt 2, also known as thread guaranteed load, refers to the ultimate load that is borne by the product without obvious plastic deformation. After the target pre-tightening force is determined, the torque to be applied by the tightening assembly 13 is also determined. According to the measured value of the torque sensor 16, it is accurately judged whether the torque to be applied by the tightening assembly 13 meets the requirements.

The tightening assembly 13 is an applying element of the torque. After the torque is applied, two pieces of data may be obtained: one is the pre-tightening force measured by the pre-tightening force detecting assembly 12, and the other is the time length data measured by the time length measuring assembly 14. According to these two pieces of data, a series of pre-tightening force coefficients can be obtained by calculation.

Specifically, in the process of tightening the nut 112, the first ultrasonic probe 142 is kept in contact with the first piezoelectric ceramic sheet 141. Therefore, according to a sampling frequency of the first ultrasonic probe 142, a plurality of groups of ultrasonic signals are collected, and each group of ultrasonic signals include the first ultrasonic signal and the second ultrasonic signal. The first ultrasonic signal is a sine wave signal transmitted from the head 2a of the bolt 2 to the tail end of the rod 2b of the bolt 2, and the other ultrasonic signal is a reflected wave signal of the first ultrasonic signal, that is, the second ultrasonic signal. Both the first ultrasonic signal and the second ultrasonic signal are sine wave signals.

Step 4, the pre-tightening force coefficient K is calculated by the following formula:

$$K = \frac{Δ t * S}{L * F} .$$

Specifically, the first controller 15 may be used to perform the above calculation operation.

Δt is a time difference between the first ultrasonic signal and the second ultrasonic signal, and Δt is calculated according to the first ultrasonic signal and the second ultrasonic signal measured by the time length measuring assembly 14. Referring to FIG. 6, Δt is obtained by adding different ultrasonic signal peaks according to different weights in the present disclosure, that is, Δt=a₁Δt₁+a₂Δt₂+ . . . +aₙΔtₙ, wherein a₁, a₂, . . . , an are weight factors, and a₁+a₂+ . . . +aₙ=1.

S is a cross-sectional area of the rod 2b of the bolt 2.

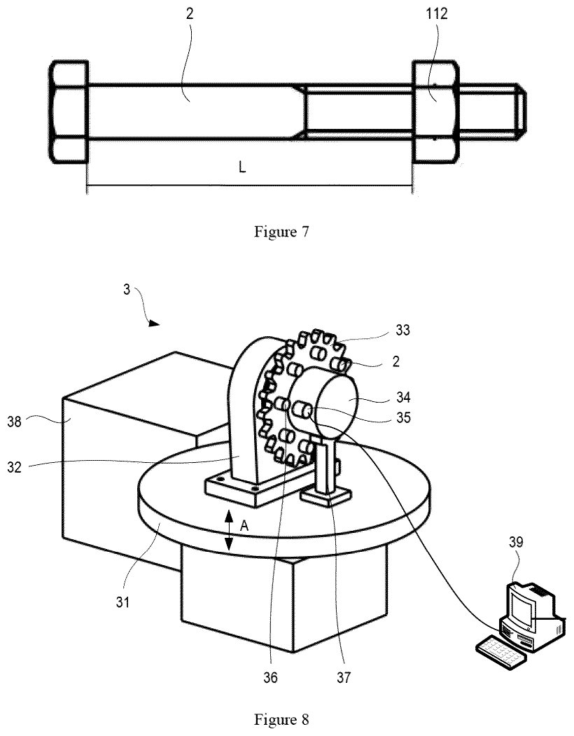

L is an effective clamping length of the bolt 2. The effective clamping length L of the bolt 2 refers to the distance between the end surface of the head 2a of the bolt 2 facing the nut 112 and the end surface of the nut 112 facing the head 2a of the bolt 2, as shown in FIG. 7.

F is the pre-tightening force measured by the pre-tightening force detecting assembly 12.

Step 5: a series of real-time pre-tightening force coefficients obtained in the previous step are averaged to obtain the pre-tightening force coefficient of the bolt 2.

Step 6: a plurality of bolts 2 are repeatedly calibrated to take the average value, for example, more than five bolts are specifically calibrated to obtain the pre-tightening force coefficient of the bolts 2 of this model.

After the pre-tightening force coefficient of the bolts 2 of this model is obtained, the vibration test device 3 is subsequently used to predict the pre-tightening force of the bolts 2 of this model.

Specifically, referring to FIGS. 1 and 8, in some embodiments, the apparatus for predicting attenuation of a pre-tightening force of a bolt further includes the vibration test device 3 configured to perform a transverse vibration test on the bolt 2.

The vibration test device 3 has various structural forms, and is used to perform transverse vibration test on the bolt 2 with the pre-tightening force coefficient calibrated by the pre-tightening force coefficient measuring device 1. Of course, the pre-tightening force of other bolts 2 of the same model as the bolt 2 of which the pre-tightening force coefficient has been calibrated by the pre-tightening force coefficient measuring device 1 may also be detected, so as to judge attenuation of the pre-tightening force of the bolts.

The vibration test device 3 specifically performs the transverse vibration test on the tested bolt 2. The transverse vibration test is an accelerated test, which is used to effectively test and judge connection performances of various bolts 2.

With continued reference to FIGS. 1 and 8, in some embodiments, the vibration test device 3 includes a vibration table 31, a support 32, a first connected part 33, a second connected part 34, a second ultrasonic probe 35 and a second piezoelectric ceramic sheet 36.

The vibration table 31 is configured to provide vibration. The direction of vibration motion applied by the vibration table 31 is perpendicular to an axial direction of the bolt 2 in a connected state. Specifically, the vibration table 31 provides vibration excitation in a vertical direction for the first connected part 33, the tested bolt 2, the second connected part 34 and other parts, so that the above parts vibrates in the vertical direction.

The support 32 is installed on the vibration table 31, and may be in threaded connection or fixation in other detachable ways. If the support 32 and the vibration table 31 are connected by the bolts 2, it should be noted that the bolts 2 between the support 32 and the vibration table 31 are not the test objects, but only the bolt 2 between the first connector 113 and the second connector 113 is the test object. The test object refers to the bolt 2 of which the pre-tightening force of the bolt needs to be judged.

The support 32 applies a supporting force consistent with the vibration direction to at least one of the first connected part 33 and the second connected part 34, so that the connected part keeps a relatively fixed position under actions of the external torque and vibration. In some embodiments, the support 32 is installed on the top surface of the vibration table 31, and the bottom of the vibration table 311 is fixed on the ground of a test site. The support 32 is fixedly connected with the first connected part 33 by the bolt 2, a spline or other forms. The tested bolt 2 only connects the first connector 113 and the second connector 113, and the first connector 113 and the support 32 are fixedly connected by other untested bolts. That is to say, the untested bolts used to connect the first connector 113 and the support 32 are not the test objects of this test.

The first connected part 33 is installed on the support 32. The second connected part 34 and the first connected part 33 are fixedly connected by the bolts 2. In some embodiments, for example, the first connected part 33 is a sprocket and the second connected part 34 is a housing. The first connected part 33 and the second connected part 34 are connected by a plurality of tested bolts 2.

The second ultrasonic probe 35 is in contact with the bolt 2 in the connected state to detect vibration of the bolt 2. The second piezoelectric ceramic sheet 36 is configured to be fixedly connected with the head 2a of the bolt 2 connecting the first connected part 33 and the second connected part 34. In an initial state, the second ultrasonic probe 35 and the second piezoelectric ceramic sheet 36 are kept separated; and in the vibration test, the second ultrasonic probe 35 and the second piezoelectric ceramic sheet 36 are kept in contact.

The second ultrasonic probe 35 may detect the ultrasonic signals of the tested bolt 2, and calculate a group of ultrasonic time differences Δt according to the measured ultrasonic signals. As mentioned above, there is a specific functional relationship between the pre-tightening force coefficient and the pre-tightening force:

$$K = \frac{Δ t * S}{L * F} .$$

Therefore, after the model of the tested bolt 2 is determined, the cross-sectional area S thereof is also determined, and after the first connector 113 and the second connector 113 connected with the bolt 2 are determined, the effective connection length L of the bolt 2 is also determined. The pre-tightening force coefficient K has been calculated by the pre-tightening force coefficient measuring device 1, and the pre-tightening force coefficient of the bolt 2 is uniquely determined according to the above step 5 and step 6. Then according to the above formula, the unique variable F in the above formula can be calculated and obtained, that is, the pre-tightening force F of the bolt 2.

With continued reference to FIGS. 1 and 8, in some embodiments, the vibration test device 3 further includes a bracket 37, and the bracket 37 is installed on the vibration table 31, and specifically may adopt threaded connection, etc. If the bolt 2 is used for connection, the bolt 2 between the bracket 37 and the vibration table 31 is not the bolt 2 to be measured, and only the connecting bolt 2 between the first connector 113 and the second connector 113 is the measured bolt 2, and is the test object. The bracket 37 is connected with the second connected part 34 to support the second connected part 34 in the vibration direction. The bracket 37 is used to support the second connected part 34 and reduce a vibration test deviation caused by a self-weight of the second connected part 34. In an initial installation state, that is, when no vibration test is performed, there is a gap between the bracket 37 and the second connector 113. In the vibration test, the bracket 37 is intermittently in contact with the second connector 113.

With continued reference to FIGS. 1 and 8, in some embodiments, the vibration test device 3 further includes a power component 38, and the power component 38 is in driving connection with the vibration table 31 to drive the vibration table 31 to vibrate. The power component 38 includes a hydraulic power station, and the hydraulic power station provides power for the vibration table 31. The hydraulic power station is connected with the vibration table 31 through a hydraulic pipeline, etc., to provide power therefor and ensure the system to work stably.

With continued reference to FIGS. 1 and 8, in some embodiments, the vibration test device 3 further includes a second controller 39, and the second controller 39 is communicatively connected with the second ultrasonic probe 35 to receive the ultrasonic signals emitted by the second ultrasonic probe 35. The second controller 39 is also in signal connection with the components such as the vibration table 31 and the hydraulic power station through cables. The second controller 39 is used to control working parameters of the elements such as the vibration table 31 and the hydraulic power station, and monitor the parameters in the test process, including a real-time torque, a push/pull force, an amplitude and a frequency.

The following describes how to use the vibration test device 3 to perform the vibration test on the bolt 2.

Step 1: the support 32, the first connected part 33, the tested bolt 2, the second connected part 34 and the bracket 37 are connected as shown in FIG. 8, the vibration table 31 and the hydraulic power station are connected to a power supply and the second controller 39 through a line, and the second controller 39 is turned on.

Step 2: the vibration test is performed to determine a vibration period T, and the vibration period is divided into i parts, denoted as T1, T2, . . . , Ti. From the initial state, the second ultrasonic probe 35 is attached to the second piezoelectric ceramic sheet 36 at the head 2a of the bolt 2, the corresponding ultrasonic signals are recorded, and the second controller 39 calculates the pre-tightening force according to the ultrasonic signals. The detection ends until the vibration period ends.

After the pre-tightening coefficient is obtained by the pre-tightening coefficient measuring device 1 and the pre-tightening force of the bolt 2 is measured by the vibration test device 3, the measured data are analyzed and processed to realize prediction on the pre-tightening force of the bolt. The second controller 39 may be used for subsequent processing operations. Specifically, data processing includes the following steps:

Step 1: original data is preprocessed to obtain a target data set.

Step 1.1: missing data vectors in the original data set are subjected to data recovery by using a linear interpolation method, and abnormal data vectors in the original data set are subjected to data recovery by using a mean smoothing method to obtain a processed bolt data set.

Step 1.2: the processed bolt data set is formed into a matrix and standardized to obtain a covariance matrix, eigenvalues of the covariance matrix are sorted from large to small, and a contribution rate of each influence factor to all influence factors is calculated. The influence factor meeting the cumulative contribution rate greater than a set value is a pre-tightening force attenuation key influence factor; and the target data set is a set of the pre-tightening force attenuation key influence factors. In some embodiments, the influence factor meeting the cumulative contribution rate of more than 85% is the pre-tightening force attenuation key influence factor.

The original parameter matrix composed of the data in terms such as a material of the bolt 2, a material of the connector 113, a friction coefficient, a surface hardness, a tightening speed, an initial pre-tightening force, a displacement amplitude and a vibration period is established. Each column of the matrix includes identical influence factors, and each row includes all types of influence factors.

$$R = [ \begin{matrix}{X}_{11} & {X}_{12} & … & {X}_{1 n} \\ {X}_{21} & {X}_{22} & … & {X}_{2 n} \\ … & … & … & … \\ {X}_{m 1} & {X}_{n 2} & … & {X}_{m n}\end{matrix} ] \qquad ( 1 )$$

According to the principal component analysis mathematical principle, the matrix R=[xᵢⱼ]_{m×n} is standardized, the covariance matrix is established, the eigenvalues are solved, the main elements of the matrix R are sorted from left to right, and the cumulative contribution rate is calculated to determine the main elements. The original parameter matrix R=[xᵢⱼ]_{m×n} is standardized to obtain X=[xᵢⱼ]_{m×n} wherein:

$${x}_{ij}^{*} = \frac{{x}_{ij} - {\overline{x}}_{j}}{{s}_{j}} , i = 1 , 2 , … , m ; j = 1 , 2 , … , {nx}_{ij}^{*} = \frac{{x}_{ij} - {\overline{x}}_{j}}{{s}_{j}} , i = 1 , 2 , … , m ; j = 1 , 2 , … , n \qquad ( 2 )$$

$${\overline{x}}_{j} = \frac{{\sum }_{i = 1}^{m} {x}_{ij}}{m} , {s}_{j}^{2} = \frac{{\sum }_{i = 1}^{m} {( {x}_{ij} - {\overline{x}}_{j} )}^{2}}{m - 1} {\overline{x}}_{j} = \frac{{\sum }_{i = 1}^{m} {x}_{ij}}{m} , {s}_{j}^{2} = \frac{{\sum }_{i = 1}^{m} {( {x}_{ij} - {\overline{x}}_{j} )}^{2}}{m - 1}$$

The covariance matrix C of the standardized matrix X is solved:

$$C = {( {r}_{i k} )}_{n \times n} , {r}_{j k} = \frac{1}{m - 1} {\sum }_{i = 1}^{m} ( {z}_{ij} , {z}_{i k} ) , j , k = 1 , 2 , … , n \qquad ( 3 )$$

The eigenvalues of matrix C are solved, and are sorted from large to small as follows:

$${λ}_{1} \geq {λ}_{2} \geq … \geq {λ}_{n}$$

The contribution rate ρi of the ith principal component is calculated:

$${ρ}_{i} = \frac{{λ}_{i}}{{\sum }_{j}^{n} {λ}_{j}} \qquad ( 4 )$$

If the cumulative contribution rate of the first 1 principal components exceeds 85%, it will be regarded as the key influence factor.

Step 2: the pre-tightening force attenuation prediction model is established. The accuracy of prediction results is verified by the transverse vibration test.

Step 2.1: a support vector regression prediction model is constructed, with the target data set composed of the pre-tightening force attenuation key factors obtained in step 1.2 as input vectors and corresponding pre-tightening forces thereof as the outputs.

Step 2.2: the change of input characteristics is controlled to obtain sufficient experimental data to train the model, so as to make correct prediction on the pre-tightening force of the bolt under untested specified working conditions, and give a confidence interval of the pre-tightening force of the bolt in probability sense to predict attenuation characteristics of a bolt connection structure. The attenuation characteristics of the bolt connection structure determine whether the bolt connection is reliable or not.

xi is assumed as the key influence factor affecting the attenuation of the pre-tightening force, y*ᵢ is assumed as the predicted value, and the model for the relationship between xi and y*ᵢ is:

$${y}_{i}^{*} = f ( {x}_{i} )$$

Specifically, the second controller 39 may be used to execute respective steps of the prediction process. The specific prediction process is as follows:

(1) Sample data is selected and preprocessed to construct a training set. The current vibration frequency segment is t, and the pre-tightening force of the next vibration frequency segment t+1 is estimated. The pre-tightening force corresponding to the current vibration frequency segment is qi, the training data set of the pre-tightening force qi(t+1) corresponding to the next vibration frequency segment takes the previous moment as a sample size, and then the training data set of the pre-tightening force qi (t+1) corresponding to the next vibration frequency segment is xi={qi(t), qi(t−1), . . . , qi(t−n)}.

(2) By analyzing known data, correlation coefficients such as a kernel function are determined. In some embodiments, the composite function formed by adding a linear kernel function and a radial kernel function is adopted as the kernel function, and this kernel function not only has the general trend of monotonic increasing of the linear kernel function, but also has the smooth change of the radial kernel function in local change of the data. The kernel function is as follows:

$$k ( x , {x}_{i} ) = {k}_{RBF} ( x , {x}_{i} ) + {k}_{LIN} ( x , {x}_{i} )$$

$$wherein {k}_{RBF} ( x , {x}_{i} ) = exp ( - γ {‖ x - {x}_{i} ‖}^{2} ) {k}_{LIN} ( x , {x}_{i} ) = {x}^{T} \cdot {x}_{i}$$

x is the vector composed of the input variables corresponding to the predicted value; x^{T} is the transposition matrix of x; xi is the vector composed of the input variables corresponding to the sample set; γ is a signal error.

(3) An optimization function is constructed, and the sample set composed of the tested key influence factors and the corresponding pre-tightening forces are taken as inputs for solving.

$$\{ \begin{matrix}min \{ \frac{1}{2} {\sum }_{i , j = 1}^{N} ( {a}_{i}^{*} - {a}_{i} ) ( {a}_{j}^{*} - {a}_{j} ) K ( {x}_{i} , {x}_{j} ) - {\sum }_{i = 1}^{N} ( {a}_{i}^{*} - {a}_{i} ) {y}_{i} + {\sum }_{i = 1}^{N} ( {a}_{i} + {a}_{i}^{*} ) ε \} \\ s . t . {\sum }_{i = 1}^{N} ( {a}_{i}^{*} - {a}_{i} ) = 0 , 0 \leq {a}_{i} , {a}_{i}^{*} \leq C , i = 1 , 2 , … , N\end{matrix}$$

wherein xi and xj represent vectors composed of different input variables; N is the number of samples, and aᵢ, a*ᵢ, aⱼ, a*ⱼ are lagrangian multipliers; C is a penalty factor; ε is an error value.

(4) An optimal decision function is solved, and the corresponding pre-tightening forces are predicted by the sample set composed of the untested key influence factors under the specified working conditions.

$$f ( x ) = {\sum }_{i = 1}^{N} ( {a}_{i}^{*} - {a}_{i} ) K ( {x}_{i} , x ) + b$$

wherein x represents the vector composed of the input variables corresponding to the predicted value, xi represents the vector composed of input variables corresponding to the sample set, aᵢ, a*ᵢ are lagrangian multipliers, and b is a coefficient of the decision function.

In order to evaluate the prediction results, the experimental results are compared with the prediction results, and the average square error MSE and the average absolute percentage error MAPE are given:

$$MSE = \frac{1}{n} {\sum }_{i = 1}^{n} {( {y}_{i} - {y}_{i}^{*} )}^{2} \times 100 \%$$

$$MAPE = \frac{1}{n} {\sum }_{i = 1}^{n} \vert \frac{{y}_{i} - {y}_{i}^{*}}{{y}_{i}} \vert \times 100 \%$$

wherein yi is a sample value, that is, the known clamping force; y*ᵢ is the predicted value, that is, the predicted clamping force, and n is the number of samples.

The following introduces the case analysis method to detect prediction effects of the above method, and the specific contents are as follows:

By taking M12 bolt 2 as a research object, the attenuation of the pre-tightening force of the bolt is predicted, and the following tests are carried out.

The pre-tightening force of the test object is calculated by the apparatus for predicting attenuation of the pre-tightening force of the bolt, and the original database is constructed. The original data set is preprocessed by a numerical method, and the key factors of data vectors included in the original data set, such as the material of the bolt 2, the material of the connector 113, the friction coefficient, the surface hardness, the tightening speed, the initial pre-tightening force, the displacement amplitude and the vibration period, are extracted by the principal component analysis method. By sorting the contribution rates of respective influence factors, the key factors affecting the attenuation of the pre-tightening force are: the initial pre-tightening force, the displacement amplitude and the vibration period.

According to the pre-tightening force attenuation key factors, a target bolt data set is established and used as input variables of the support vector regression prediction model for data training, and the number of sample training is N=220.

Then, respective parameters in the kernel function are set, and the kernel function has an unknown parameter signal error γ in total, which is given an initial value γ=2 to obtain the complete kernel function.

The data in the target data set is substituted into the kernel function to calculate the covariance matrix k(x,xi).

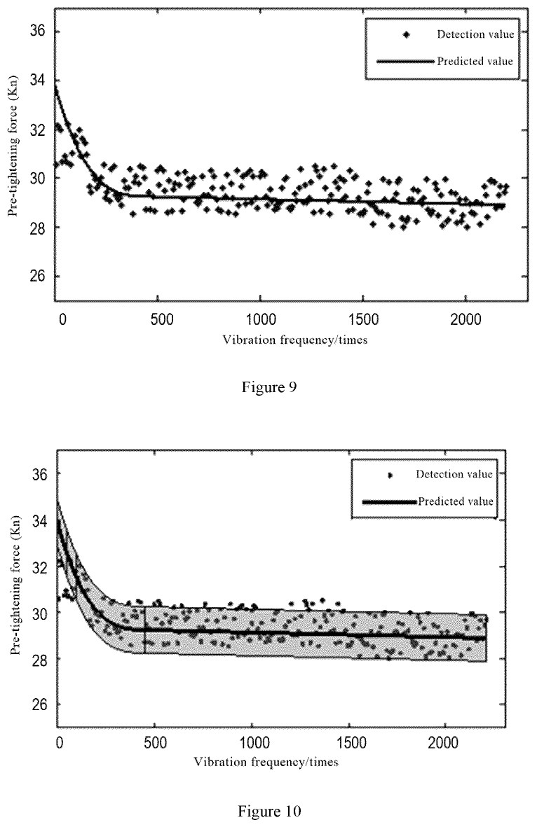

Finally, the calculated covariance matrix is substituted into the support vector regression prediction model to obtain the predicted pre-tightening force value. The prediction results of the support vector regression prediction model are as shown in FIG. 9, and the 95% confidence interval thereof is as shown in FIG. 10. By comparing FIGS. 9 and 10, it can be seen that the pre-tightening force of the bolt 2 can be effectively predicted by using the method for predicting attenuation of the pre-tightening force of the bolt according to the embodiment of the present disclosure.

In the descriptions of the present disclosure, it should be understood that the orientation or positional relationships indicated by terms such as “center”, “longitudinal”, “transverse”, “front”, “rear”, “left”, “right”, “vertical”, “horizontal”, “top”, “bottom”, “inner” and “outer” are based on the orientation or positional relationships shown in the drawings, only for the purposes of the ease in describing the present disclosure and simplification of its descriptions, but not indicating or implying that the specified device or element must be specifically located, and structured and operated in a specific direction, and therefore, should not be understood as limitations to the protective scope of the present disclosure.

Finally, it should be noted that the above embodiments are only used for illustrating rather than limiting the technical solutions of the present disclosure; although the present disclosure has been described in detail with reference to the preferred embodiments, those of ordinary skill in the art should understand that modifications can still be made to the specific embodiments of the present disclosure or equivalent substitutions can be made to part of technical features; and without departing from the spirit of the technical solutions of the present disclosure, the modifications and equivalent substitutions should be included in the scope of the technical solutions claimed in the present disclosure.

1. An apparatus for predicting attenuation of a pre-tightening force of a bolt, comprising:
a pre-tightening force coefficient measuring device, comprising a clamping assembly, a pre-tightening force detecting assembly, a tightening assembly and a time length measuring assembly; wherein the clamping assembly is configured to fix a bolt to be detected; the tightening assembly is configured to apply a pre-tightening force to the bolt; the time length measuring assembly is configured to measure a time length of each sampling in the process of tightening the bolt by the tightening assembly; and the pre-tightening force detecting assembly is configured to measure the pre-tightening force to the bolt.

2. The apparatus for predicting attenuation of a pre-tightening force of a bolt according to claim 1, wherein the clamping assembly comprises:
a clamp having a first through hole; wherein the first through hole comprises a first hole section and a second hole section; an opening size of the first hole section is greater than an opening size of the second hole section; the first hole section is configured to accommodate a head of the bolt, and the second hole section is configured to be penetrated by a rod of the bolt; and
a nut configured to be in threaded connection with part of the rod of the bolt extending out of the second hole section.

3. The apparatus for predicting attenuation of a pre-tightening force of a bolt according to claim 2, wherein the clamping assembly further comprises:
a connector having a second through hole; the connector being disposed between the clamp and the nut.

4. The apparatus for predicting attenuation of a pre-tightening force of a bolt according to claim 3, wherein the pre-tightening force detecting assembly has a third through hole; and the pre-tightening force detecting assembly is disposed between the connector and the clamp.

5. The apparatus for predicting attenuation of a pre-tightening force of a bolt according to claim 3, wherein the tightening assembly is connected with the nut to clamp the clamp, the pre-tightening force detecting assembly and the connector which are located between the head of the bolt and the nut by rotating the bolt, so as to apply the pre-tightening force to the bolt.

6. The apparatus for predicting attenuation of a pre-tightening force of a bolt according to claim 1, wherein the time length measuring assembly comprises:
a first piezoelectric ceramic sheet fixedly connected with the head of the bolt;
a first ultrasonic probe disposed corresponding to the first piezoelectric ceramic sheet; and
a driving mechanism in driving connection with the first ultrasonic probe to drive the first ultrasonic probe to move linearly so as to contact and separate from the first piezoelectric ceramic sheet.

7. The apparatus for predicting attenuation of a pre-tightening force of a bolt according to claim 6, wherein the driving mechanism comprises:
a driving source comprising a piston rod; and
an elastic member, one end of which being installed on the piston rod of the driving source, and the other end of which being fixedly connected with the first ultrasonic probe.

8. (canceled)

9. The apparatus for predicting attenuation of a pre-tightening force of a bolt according to claim 6, further comprising:
a first controller in communication with the first ultrasonic probe to receive ultrasonic signals sent by the first ultrasonic probe.

10. The apparatus for predicting attenuation of a pre-tightening force of a bolt according to claim 1, wherein the pre-tightening force coefficient measuring device further comprises:
a torque sensor connected with the tightening assembly to detect a torque applied by the tightening assembly.

11. The apparatus for predicting attenuation of a pre-tightening force of a bolt according to claim 1, comprising:
a vibration test device configured to perform a transverse vibration test on the bolt;
wherein the vibration test device comprises:
a vibration table configured to provide vibration;
a support installed on the vibration table;
a first connected part installed on the support;
a second connected part fixedly connected with the first connected part through the bolt;
a second ultrasonic probe configured to detect vibration of the bolt; and
a second piezoelectric ceramic sheet configured to be fixedly connected with the head of the bolt connecting the first connected part and the second connected part;
wherein the direction of vibration motion applied by the vibration table is perpendicular to an axial direction of the bolt in a connected state; in an initial state, the second ultrasonic probe and the second piezoelectric ceramic sheet are kept separated; and in the vibration test, the second ultrasonic probe and the second piezoelectric ceramic sheet are kept in contact.

12. (canceled)

13. (canceled)

14. (canceled)

15. The apparatus for predicting attenuation of a pre-tightening force of a bolt according to claim 1, wherein the vibration test device further comprises:
a second controller communicatively connected with the second ultrasonic probe to receive ultrasonic signals sent by the second ultrasonic probe.

16. A method for predicting attenuation of a pre-tightening force of a bolt, comprising the following steps:
calibrating a pre-tightening force coefficient of a bolt to be detected to obtain a data set of the corresponding relationship between a pre-tightening force and the pre-tightening force coefficient;
performing a transverse vibration test on the bolt to obtain an original data set of the pre-tightening force;
processing the original data set to obtain a target data set; and
establishing, according to the target data set, a pre-tightening force attenuation prediction model.

17. The method for predicting attenuation of a pre-tightening force of a bolt according to claim 16, wherein the step of processing the original data set to obtain the target data set comprises:
performing data recovery on missing data vectors in the original data set by adopting a linear interpolation method, and performing data recovery on abnormal data vectors in the original data set by adopting a mean smoothing method to obtain a processed bolt data set;
forming the processed bolt data set into a matrix and performing standardization to obtain a covariance matrix, and sorting eigenvalues of the covariance matrix from large to small to calculate a contribution rate of each influence factor to all influence factors; wherein the influence factor meeting the cumulative contribution rate greater than a set value is a pre-tightening force attenuation key influence factor; and the target data set is a set of the pre-tightening force attenuation key influence factors.

18. The method for predicting attenuation of a pre-tightening force of a bolt according to claim 17, wherein the set value is 80%-90%.

19. The method for predicting attenuation of a pre-tightening force of a bolt according to claim 16, wherein the step of establishing the pre-tightening force attenuation prediction model according to the target data set comprises:
constructing a support vector regression prediction model, and taking the target data set composed of the pre-tightening force attenuation key factors as input vectors and corresponding pre-tightening forces thereof as outputs; and
training the support vector regression prediction model, and giving a confidence interval of the pre-tightening force of the bolt in probability sense to predict attenuation characteristics of a bolt connection structure.

20. The method for predicting attenuation of a pre-tightening force of a bolt according to claim 19, wherein the step of training the support vector regression prediction model and giving the confidence interval of the pre-tightening force of the bolt in probability sense to predict the attenuation characteristics of the bolt connection structure comprises:
preprocessing an experimental data pair model obtained from the vector regression prediction model to construct a training set;
determining, according to the training set, a kernel function;
constructing an optimization function, and solving by taking a sample set composed of tested key influence factors and the corresponding pre-tightening forces as inputs; and
solving an optimal decision function, and predicting the corresponding pre-tightening forces by a sample set composed of untested key influence factors under specified working conditions.

21. The method for predicting attenuation of a pre-tightening force of a bolt according to claim 20, wherein the function xi of the training set is as follows:
$${x}_{i} = \{ {q}_{i} ( t ) , {q}_{i} ( t - 1 ) , … , {q}_{i} ( t - n ) \}$$
wherein qᵢ(t) is the pre-tightening force corresponding to a current vibration frequency segment, and qᵢ(t−1) is the pre-tightening force corresponding to a previous vibration frequency segment; qᵢ(t−n) is the pre-tightening force corresponding to first n vibration frequency segments.

22. The method for predicting attenuation of a pre-tightening force of a bolt according to claim 21, wherein the kernel function k(x,xi) is:
$$k ( x , {x}_{i} ) = {k}_{RBF} ( x , {x}_{i} ) + {k}_{LIN} ( x , {x}_{i} )$$
$$wherein$$
$${k}_{RBF} ( x , {x}_{i} ) = exp ( - γ {‖ x - {x}_{i} ‖}^{2} )$$
$${k}_{LIN} ( x , {x}_{i} ) = {x}^{T} \cdot {x}_{i}$$
x is the vector composed of input variables corresponding to a predicted value; x^{T} is a transposition matrix of x; xᵢ is the vector composed of input variables corresponding to the sample set; γ is a signal error.

23. The method for predicting attenuation of a pre-tightening force of a bolt according to claim 20, wherein the optimization function is as follows:
$$\{ \begin{matrix}min \{ \frac{1}{2} {\sum }_{i , j = 1}^{N} ( {a}_{i}^{*} - {a}_{i} ) ( {a}_{j}^{*} - {a}_{j} ) K ( {x}_{i} , {x}_{j} ) - {\sum }_{i = 1}^{N} ( {a}_{i}^{*} - {a}_{i} ) {y}_{i} + {\sum }_{i = 1}^{N} ( {a}_{i} + {a}_{i}^{*} ) ε \} \\ s . t . {\sum }_{i = 1}^{N} ( {a}_{i}^{*} - {a}_{i} ) = 0 , 0 \leq {a}_{i} , {a}_{i}^{*} \leq C , i = 1 , 2 , … , N\end{matrix}$$
wherein xᵢ and xⱼ represent the vectors composed of different input variables; N is the number of samples, and aᵢ, a*ᵢ, aⱼ, a*ⱼ are lagrangian multipliers; c is a penalty factor; ε is an error value.

24. The method for predicting attenuation of a pre-tightening force of a bolt according to claim 21, wherein the decision function is as follows:
$$f ( x ) = {\sum }_{i = 1}^{N} ( {a}_{i}^{*} - {a}_{i} ) K ( {x}_{i} , x ) + b$$
wherein x represents the vector composed of input variables corresponding to the predicted value, xᵢ represents the vector composed of input variables corresponding to the sample set, aᵢ, a*ᵢ are lagrangian multipliers, and b is a coefficient of the decision function.
